(19) United States
(12) Patent Application Publication
(10) Pub. No.: US 2013/0122287 A1
(43) Pub. Date: May 16, 2013

(54) HOT-MELT ADHESIVE COMPRISING IONIC GROUPS

(71) Applicants: Thomas Moeller, Duesseldorf (DE); Melanie Lack, Duesseldorf (DE); Andrea Krlejova, Duesseldorf (DE); Riju Davis, Duesseldorf (DE)

(72) Inventors: Thomas Moeller, Duesseldorf (DE); Melanie Lack, Duesseldorf (DE); Andrea Krlejova, Duesseldorf (DE); Riju Davis, Duesseldorf (DE)

(73) Assignee: Henkel AG & Co. KGaA, Duesseldorf (DE)

(21) Appl. No.: 13/602,888

(22) Filed: Sep. 4, 2012

Related U.S. Application Data
(63) Continuation of application No. PCT/EP2011/053192, filed on Mar. 3, 2011.

(30) Foreign Application Priority Data
Mar. 5, 2010 (DE) 10 2010 002 622.0

(51) Int. Cl. C09J 175/04; C09J 7/02

(52) U.S. Cl. CPC C09J 175/04; C09J 7/0207
USPC 428/339; 522/174; 522/175; 428/355 N

(57) ABSTRACT

Discussed are hot-melt adhesives that can be cross-linked by radiation. The adhesives comprise more than 30%, relative to the hot-melt adhesive, of at least one polyurethane polymer which contains at least one reactive group that can be polymerized by radiation.

The present invention relates to radiation-curable hot-melt adhesives having good adhesion based on reactive polyurethanes, which can be used for example for bonding films on various substrates.

Radiation-curing adhesives are generally known. For example, free-flowing, often low-viscosity adhesives are cured by free-radical or cationic polymerization, and contact adhesives or firmly bonded layers are formed. The polymers must be adapted to the substrate surfaces to ensure good adhesion.

Adhesives for bonding plastics labels onto packaging, such as bottles or cans, are one area of application. To ensure good adhesion to the substrate, sleeve-like shrink labels are often used. Machines and methods are known for applying wrap-around labels of this type onto rotationally symmetrical objects. These labels are then produced by bonding. Mostly thin adhesive layers are applied in this case.

Radiation-curing hot-melt adhesives are known, e.g. from DE 4041753 A1 or WO 02/34858. In this document, urethane-based coating compositions that can be polymerized in two stages are described, which are set by a content of UV-polymerizable acrylate groups in a first curing stage, and in a subsequent second stage, irreversible crosslinking takes place via isocyanate groups. To lower the viscosity, monofunctional acrylates are added to the adhesive as reactive diluents. However, isocyanate-containing adhesives can be harmful to health.

In EP 1262502, a linear polymer is described which has a polyester backbone and contains an unsaturated double bond at one end of the chain and an alcohol reacted on at the other end. No adhesives are described there which carry the initiator groups reacted onto the base polymer.

In DE 102007015801, adhesives are described which can be used as an adhesive for the bonding of labels. Radiation-curable prepolymers which are produced on the basis of polyether or polyester polyurethane prepolymers are also there. Only conventional polyols are described; a targeted synthesis of polymer chains comprising anionic or cationic groups is not described.

UV-curing adhesives are also known from WO 2005/105857. Reaction products of a polyester diol and a polyether polyol together with an OH-functional acrylate, which are reacted with polyisocyanates, are described there. These prepolymers are then mixed with monomeric acrylates and initiators and used as a reactive adhesive.

However, the known radiation-curable adhesives have the disadvantage that their adhesion to plastics substrates can be improved. If different environmental influences regularly act on the bonded site, for example in sites that may be exposed to daily weathering, the bond can be further improved. Furthermore, it is common for label bonding to apply the adhesive only in a thin layer. Curing in a thick layer with good adhesive strength and elastic bonding is often impossible to achieve.

It is therefore an object of the present invention a radiation-curable adhesive, wherein the bond after curing permits a permanent load even under alternating thermal stress and which is distinguished by good adhesion to plastics surfaces. In addition, the adhesive should be capable of being applied and cured even in a relatively thick layer.

The object is achieved by providing a radiation-curing hot-melt adhesive according to the claims. A radiation-curable hot-melt adhesive is provided here which contains more than 30 wt. %, based on the hot-melt adhesive, of at least one polyurethane polymer having at least one radiation-polymerizable reactive group, produced by reaction of a) a reactive PU prepolymer with two or three NCO groups per molecule and at least one carboxyl group or tertiary amino group, produced from—i) a mixture of at least one di- or trifunctional polyol selected from polyether polyols or polyester polyols having a molecular weight of between 200 and 5000 g/mol together with a diol component, which additionally has a carboxyl group or tertiary amino group, reacted with—ii) an excess of at least one di- or triisocyanate having a molecular weight of less than 500 g/mol, b) 20 to 98 mole % of at least one low-molecular-weight compound (B) containing a free-radically polymerizable double bond and a group reacting with an NCO group, and c) 0 to 50 mole % of at least one compound (C), which has at least one group that is reactive towards NCO groups but no group that can be polymerized under free-radical conditions, having a molecular weight of 32 to 5000 g/mol, and d) 2 to 50 mole % of at least one free-radical photoinitiator (D) which has a primary or secondary OH group, wherein the data are based on the NCO groups of the PU prepolymer and the sum of B, C and D should add up to 100 mole %, and optionally other auxiliary substances.

The invention also provides the use of such hot-melt adhesives with radiation-curable functional groups for bonding films onto mineral surfaces. The invention also provides the use of such hot-melt adhesives for bonding onto plastics surfaces.

The hot-melt adhesive according to the invention substantially consists of a PU polymer having terminal radiation-curable reactive double bonds. Furthermore, the PU polymer contains chemically bound initiators. The polymer skeleton must also contain ionic groups or groups that can be converted into ionic groups. In another embodiment, the PU prepolymer additionally contains free, non-crosslinkable polymer chain ends. The PU polymer will be produced from an NCO-reactive polyurethane prepolymer.

The polyurethane prepolymer A) as the basis for further reactions is produced by reacting diol building blocks and/or triol building blocks with di- or triisocyanate compounds. The quantitative ratios are selected here so that terminally NCO-functionalized prepolymers are obtained. As a further building block, diol compounds should be contained which additionally have a tertiary amino group or a carboxylic or sulfonic acid group. In particular, the PU prepolymers should be linear, i.e. predominantly made from diols and diisocyanates. An additional use of small proportions of trifunctional polyols or isocyanates is possible. The polyols and polyisocyanates that can be used in the synthesis of the prepolymers are known to the person skilled in the art.

These are the monomeric di- or triisocyanates known for adhesives applications. Examples of suitable monomeric polyisocyanates are 1,5-naphthylene diisocyanate, 2,2′-, 2,4- and/or 4,4′-diphenylmethane diisocyanate (MDI), hydrogenated MDI (H12MDI), allophanates of MDI, xylylene diisocyanate (XDI), tetramethylxylylene diisocyanate (TMXDI), 4,4′-diphenyldimethylmethane diisocyanate, di- and tetraalkylene diphenylmethane diisocyanate, 4,4′-dibenzyl diisocyanate, 1,3-phenylene diisocyanate, 1,4-phenylene diisocyanate, the isomers of toluene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenylperfluoroethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, phthalic acid bisisocyanatoethyl ester, trimethyl hexamethylene diisocyanate, 1,4-diisocyanatobutane, 1,12-diisocyanatododecane and dimer fatty acid diisocyanate. Particularly suitable are aliphatic isocyanates, such as hexamethylene diisocyanate, undecane-, dodecamethylene diisocyanate, 2,2,4-trimethylhexane-2,3,3-trimethyl-hexamethylene, 1,3- or 1,4-cyclohexane diisocyanate, 1,3- or 1,4-tetramethylxylene diisocyanate, isophorone diisocyanate, 4,4-dicyclohexylmethane-, lysine ester diisocyanate or tetramethylxylylene diisocyanate (TMXDI).

Suitable as trifunctional isocyanates are polyisocyanates formed by trimerization or oligomerization of diisocyanates or by reaction of diisocyanates with polyfunctional compounds containing hydroxyl or amino groups. Isocyanates suitable for the production of trimers are the diisocyanates already mentioned above, with the trimerization products of HDI, TMXDI or IPDI being particularly preferred.

In a particular embodiment, polyisocyanates having a uretdione, isocyanurate, allophanate, biuret, iminooxathiazinedione and/or oxadiazinetrione structure can also be contained. Preferred are PU prepolymers based on aliphatic or cycloaliphatic polyisocyanates or oligomers based on HDI, IPDI and/or 2,4′- or 4,4′-diisocyanatodicyclohexylmethane.

As di- or trifunctional polyols, the known polyols having a molecular weight of up to 20000 g/mol can be selected. They should, for example, be selected based on polyethers, polyesters, polyolefins, polyacrylates or polyamides, and these polymers must additionally contain OH groups. Polyols having terminal OH groups are preferred.

In the context of the present invention, polyesters that are suitable as a polyol for the production of the PU prepolymer can be obtained by polycondensation of acid and alcohol components, in particular by polycondensation of a polycarboxylic acid or of a mixture of two or more polycarboxylic acids and a polyol or a mixture of two or more polyols. Suitable polycarboxylic acids are those with an aliphatic, cycloaliphatic, aromatic or heterocyclic parent substance. Optionally, instead of the free carboxylic acids, acid anhydrides or esters thereof with C₁₋₅ monoalcohols can also be used for the polycondensation.

As diols to react with the polycarboxylic acids, a variety of polyols can be used. For example, aliphatic polyols having 2 to 4 primary or secondary OH groups per molecule and 2 to 20 C atoms are suitable. It is also possible to use a proportion of relatively high-functionality alcohols. Other polyester polyols can be produced on the basis of polycaprolactones. Methods for producing such polyester polyols are known to the person skilled in the art and these products are commercially available. A particular embodiment of the invention uses polyester diols which additionally contain carboxyl groups in the synthesis of the PU prepolymer. These polyesters can, for example, be obtained by using small proportions of tricarboxylic acids in the synthesis.

Furthermore, polyether polyols can be used as a polyol. Polyether polyols are preferably obtained by reaction of low molecular weight polyols with alkylene oxides. The alkylene oxides preferably have two to four C atoms. Suitable examples are the reaction products of ethylene glycol, propylene glycol or the isomeric butanediols with ethylene oxide, propylene oxide or butylene oxide. Reaction products of polyfunctional alcohols, such as glycerol, trimethylolethane or trimethylolpropane, pentaerythritol or sugar alcohols, with the above-mentioned alkylene oxides to form polyether polyols are also suitable. These can be random polymers or block copolymers. Particularly suitable are polyether polyols obtainable from the reactions mentioned having a molecular weight of about 200 to about 20 000 g/mol, preferably of about 400 to about 6 000 g/mol.

Other suitable polyols can be produced on the basis of polyacrylates. These are polymers produced by polymerization of poly(meth)acrylic esters. Other copolymerizable monomers may optionally also be contained in small proportions. The acrylates according to the invention should have two OH groups. These can preferably be present terminally in the polymer. Such OH-functional poly(meth)acrylates are known to the person skilled in the art.

OH-functionalized polyolefins are another suitable class of polyols. Polyolefins are known to the person skilled in the art and can be produced in many molecular weights. Such polyolefins based on ethylene, propylene or higher-chain α-olefins as homo- or copolymers can be functionalized either by copolymerization of monomers containing functional groups or by grafting reactions. Another possibility is that these base polymers are subsequently provided with OH-functional groups, for example by oxidation. In another embodiment, the polyolefins additionally have COOH groups. These can be reacted into the polymer, for example, by copolymerization or by grafting with maleic anhydride.

The polyols that are suitable according to the invention for producing the PU prepolymers should have a molecular weight of between 200 and 20 000 g/mol. In particular, the molecular weight should be less than 12 000 g/mol. In the case of polyether polyols, the molecular weight should in particular be between 400 and 12 000 g/mol. In the case of polyester polyols, the molecular weight should preferably be between 600 and 2500 g/mol (number average molecular weight, M_{N}, as can be determined by GPC, polystyrene standard). Particularly suitable are linear polyether polyols, polyester polyols or mixtures thereof.

According to the invention it is necessary that, together with the above-mentioned polyols, further low-molecular-weight compounds two isocyanate-reactive groups are used, which additionally contain at least one ionic group or group that can be converted into ionic groups. These can be compounds which have a molecular weight of approx. 90 to 1000 g/mol and in particular less than 500 g/mol. Preferably, two OH groups should be contained. A further embodiment contains two NRH groups. In less preferred embodiments, SH groups can also be contained. It is advantageous if they are primary, for example OH groups.

As an ionic group or group that can be converted into an ionic group, preferably tert. amino groups or carboxyl, phosphonic acid, phosphoric acid or sulfonic acid groups are suitable. One to three groups can be present, preferably one group and in particular a carboxyl group. Examples of such compounds are hydroxyalkanecarboxylic acids, such as hydroxyacetic acid, 2- or 3-hydroxypropanoic acid, mandelic acid, 2-, 3- or 4-hydroxybutanoic acid, hydroxyisobutanoic acid, hydroxypentanoic acid, hydroxyisopentanoic acid, hydroxyhexanoic acid, hydroxydodecanoic acid, hydroxypentadecanoic acid, hydroxyhexadecanoic acid or ricinoleic acid. Also possible are dihydroxyalkanecarboxylic acids, such as dimethylolpropionic acid (DMPA). DMPA is particularly preferred. Also possible are carboxylic acids having two phenolic OH groups, such as dihydroxybenzoic acid or dihydroxydicarboxylic acids, such as tartaric acid. Also possible are sulfonic acids, such as 3-aminopropanesulfonic acid, N-3-(2-aminoethyl)aminopropylsulfonic acid, 2,5-dihydroxybenzenesulfonic acid, 4,5-dihydroxy-1,3-benzenedisulfonic acid or salts thereof, phosphonic acids, such as 3-aminopropanephosphonic acid, 1-hydroxyethylidene diphosphonic acid or N-(2-hydroxyethyl)iminobis(methylphosphonic acid). Also possible are alkyldialkanolamines, such as alkyl dimethanolamines, alkyl diethanolamines, alkyl dipropanolamines; examples are N-methyldiethanolamine, N-methyldipropanolamine and N-(2,3-dihydroxypropyl)piperidine. N-Alkyldialkanolamines are preferably used or, in particular, dihydroxycarboxylic acids. Only one type of ionic group is present, and preferably only one compound is reacted. By means of the selection of the compounds and the reaction conditions, it is ensured that substantially only the OH groups or NHR groups react with the isocyanates.

The quantity of additional ionic groups is selected so that, in the prepolymer obtained, 0.05 to 1 mmol/g, preferably 0.07 to 0.7 mmol/g and particularly preferably 0.1 to 0.5 mmol/g of acid or tert. amino groups are contained. One embodiment of the invention operates in such a way that, in the synthesis of the prepolymers, the compounds containing ionic groups are reacted in a mixture with the polyols. Another embodiment first produces prepolymers which, in a further reaction stage, are subsequently reacted with the difunctional compounds having an additional acid or amino group and chain extended.

Preferably, prepolymers of the aforementioned polyisocyanates and polyols based on polyether and/or polyester diols are produced. In particular, mixtures of the two types of polyol should be used in the synthesis. One embodiment contains tertiary amino groups in the chain and another preferred embodiment contains carboxyl groups. The resulting reactive PU prepolymers A) are NCO-reactive and carry 3 or preferably 2 isocyanate groups.

The reaction of the polyols with the polyisocyanates can take place, for example, in the presence of solvents, but it is preferable to work in solvent-free form. To accelerate the reaction, the temperature is usually increased, for example between 30 and 130° C., preferably 35 to 100° C. and in particular from 40 to 80° C. To accelerate the reaction, catalysts that are conventional in polyurethane chemistry can optionally be added to the reaction mixture. The addition of dibutyltin dilaurate, dimethyltin dineodecanoate or diazabicyclooctane (DABCO) is preferred. The quantity here should be from about 0.001 wt. % to about 0.1 wt. % of the prepolymer.

In another reaction, the NCO groups are partially reacted with compounds B) which carry a functional group capable of reacting with isocyanates and, as a further functional group, a double bond that can be crosslinked by free-radical polymerization. These typically have a molecular weight of less than 1500 g/mol.

Examples of such compounds are esters of α,β-unsaturated carboxylic acids with low-molecular-weight, particularly aliphatic, alcohols which also carry a further OH group in the alkyl residue. Examples of such carboxylic acids are acrylic acids, methacrylic acid, crotonic acids, itaconic acid, fumaric acid semiesters and maleic acid semiesters. Corresponding OH group-containing esters of (meth)acrylic acid are e.g. 2-hydroxyethyl(meth)acrylamide, 2-hydroxyethyl(meth)acrylate, 2-hydroxypropyl(meth)acrylate, 3-hydroxypropyl(meth)acrylate, 3-hydroxypropyl(meth)acrylamide, N-hydroxyethyl(meth)acrylamide, reaction products of glycidyl ethers or esters with acrylic or methacrylic acid, for example reaction products of versatic acid glycidyl esters with acrylic or methacrylic acid, adducts of ethylene oxide or propylene oxide to (meth)acrylic acid, reaction products of hydroxyl acrylates with ε-caprolactone or partial transesterification products of polyalcohols, such as pentaerythritol, glycerol or trimethylolpropane, with (meth)acrylic acid.

The quantity of the OH-functional compound with free-radically polymerizable double bonds is selected so that 20 to 98 mole %, in particular 22 to 90 mole %, preferably 25 to 85 mole %, based on the NCO groups of the PU prepolymer, are used. A preferred embodiment uses a mixture of methacrylate and acrylate esters, wherein in particular the proportion of acrylates makes up at least 20 mole % and in particular at least 25 mole % of the mixture.

Furthermore, it is possible for the NCO-reactive PU prepolymer to be reacted with at least one compound C) having at least one isocyanate-reactive group, and apart from that no other group that can be polymerized under free-radical conditions. Examples of such isocyanate-reactive groups are OH, SH or NHR groups. These compounds C) should have a molecular weight of between 32 and 10 000 g/mol, in particular between 40 and 4000 g/mol.

Suitable monofunctional compounds are, for example, alcohols having 1 to 36 C atoms, such as e.g. methanol, ethanol, propanol, and higher homologues, and the corresponding thio compounds, e.g. having a molecular weight of between 40 and 1000 g/mol. Furthermore, monohydroxy- or monoamino-functional polymers having a molecular weight of less than 10 000 g/mol, in particular from 1000 to 4000 g/mol, can also be used. Mixtures of low-molecular-weight and polymeric building blocks are also possible. In particular, the functional group should be an OH group.

Higher functional compounds are also suitable. Examples of these are diols, triols or polyols, preferably diols or triols, in particular diols. Suitable compounds are e.g. polyols having 2 to 44 C atoms, e.g. ethylene glycol, propanediol, butanediol and higher homologues, and the corresponding thio compounds. The quantities of these polyols are selected in this embodiment so that a suitable molar excess of this reactive functionality is present with respect to the NCO groups. A chain extension of the NCO prepolymers can take place, but preferably only one OH group should be reacted, and free OH groups are obtained. The molecular weight of this higher-functional compound C) should be up to 10 000 g/mol and in particular from 200 to 3000 g/mol. It is also possible to use SH or NH polymers. The quantity of component C) should be 0 to 50 mole % and in particular 2 to 35 mole %.

As another necessary component reacted onto the prepolymer, a photoinitiator (D) is used which, when irradiated with light having a wavelength of about 215 nm to about 480 nm, is capable of initiating a free-radical polymerization of olefinically unsaturated double bonds. In the context of the present invention, in principle all commercially available photoinitiators that are compatible with the hot-melt adhesive according to the invention are suitable.

For example, these are all Norrish type I fragmenting and Norrish type II substances. Examples of these are photoinitiators of the Kayacure series (manufactured by Nippon Kayaku), Trigonal 14 (manufacturer: Akzo), photoinitiators of the Irgacure® and Darocure® series (manufacturer: Ciba-Geigy), Speedcure® series (manufacturer Lambson), Esacure series (manufacturer: Fratelli Lamberti) or Fi-4 (manufacturer Eastman).

From these initiators, those that have at least one NCO-reactive OH group, for example a primary or secondary OH group and in particular an aliphatic OH group, are selected according to the invention. This OH group should react with some of the NCO groups of the PU prepolymer and should be present bound to the polymer. The quantity of the reactive initiators should be at least 1 mole %, based on the NCO groups of the PU prepolymer, in particular between 4 and 50 mole % and preferably between 10 and 30 mole %.

The selected initiator is added in the context of the polymer synthesis, in which case the sum of components B, C and D should add up to 100 mole %, based on the NCO groups of the PU prepolymer. The reaction methods for reacting the reactive PU prepolymers are known to the person skilled in the art. A reaction can take place in a mixture, or the constituents can be reacted sequentially. After the reaction, randomly functionalized PU polymers are obtained.

The PU polymer should have a molecular weight of less than 200 000 g/mol, in particular between 1000 and 100 000 g/mol, preferably between 2000 and 50 000 g/mol and in particular less than 20 000 g/mol. The PU polymer should be substantially free from isocyanate groups, i.e. after the conversion reaction only traces of unreacted NCO groups should be contained. The quantity should be below 0.1% (based on the prepolymer) and particularly preferably less than 0.05%.

In addition, the hot-melt adhesive can also contain proportions of reactive diluents. Suitable as reactive diluents are, in particular, those compounds that have one or more reactive functional groups polymerizable by irradiation with UV light or with electron beams.

In particular, difunctional or higher functional acrylate or methacrylate esters are suitable. These acrylate or methacrylate esters include, for example, esters of acrylic acid or methacrylic acid with aromatic, aliphatic or cycloaliphatic polyols or acrylate esters of polyether alcohols.

Other suitable compounds are, for example, the acrylic or methacrylic esters of aromatic, cycloaliphatic, aliphatic, linear or branched C₄₋₂₀ monoalcohols or of corresponding ether alcohols. Examples of such compounds are 2-ethylhexyl acrylate, octyl/decyl acrylate, isobornyl acrylate, 3-methoxybutyl acrylate, 2-phenoxyethyl acrylate, benzyl acrylate or 2-methoxypropyl acrylate, neopentyl glycol di(meth)acrylate, 1,6-hexanediol di(meth)acrylate, trimethylolpropane tri(meth)acrylate, pentaerythritol tetra(meth)acrylate and (meth)acrylate esters of sorbitol and other sugar alcohols. These (meth)acrylate esters of aliphatic or cycloaliphatic diols can optionally be modified with an aliphatic ester or an alkylene oxide. The acrylates modified by an aliphatic ester include, for example, neopentyl glycol hydroxypivalate di(meth)acrylate, caprolactone-modified neopentyl glycol hydroxypivalate di(meth)acrylates and the like. The alkylene oxide-modified acrylate compounds include, for example, ethylene oxide-modified neopentyl glycol di(meth)acrylates, propylene oxide-modified neopentyl glycol di(meth)acrylates, ethylene oxide-modified 1,6-hexanediol di(meth)acrylates or propylene oxide-modified 1,6-hexanediol di(meth)acrylates, neopentyl glycol-modified (meth)acrylates, trimethylolpropane di(meth)acrylates, polyethylene glycol di(meth)acrylates, polypropylene glycol di(meth)acrylates and the like. Tri- and higher-functional acrylate monomers include, for example, trimethylolpropane tri(meth)acrylate, pentaerythritol tri- and tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl] isocyanurate, caprolactone-modified tris[(meth)acryloxyethyl]isocyanurates or trimethylolpropane tetra(meth)acrylate or mixtures of two or more thereof.

As reactive diluents, in particular (meth)acrylic esters which contain three to six (meth)acrylic groups are suitable. The quantity can be from 0 to 10 wt. %, in particular more than 0.1 wt. % and preferably 2 to 5 wt. %. These substances increase the cohesion of this hot-melt adhesive according to the invention.

The auxiliary substances and additives that can additionally be used in the hot-melt adhesive in the context of the present invention include, for example, plasticizers, stabilizers, antioxidants, adhesion promoters, resins, polymers, dyes or fillers.

In one embodiment, the hot-melt adhesive according to the invention contains at least one tackifying resin. The resin provides extra tack. In principle, all resins which are compatible with the hot-melt adhesive, i.e. form a largely homogeneous mixture, can be used.

These are in particular resins having a softening point of 70 to 140° C. (ring and ball method, DIN 52011). They are, for example, aromatic, aliphatic or cycloaliphatic hydrocarbon resins, and modified or hydrogenated versions thereof. Examples of these are aliphatic or alicyclic petroleum hydrocarbon resins and hydrogenated derivatives thereof. Other resins that can be used in the context of the invention are e.g. hydroabietyl alcohol and esters thereof, in particular esters with aromatic carboxylic acids, such as terephthalic acid and phthalic acid; modified natural resins, such as rosin acids from gum rosin, tall oil rosin or wood rosin, e.g. partially or completely saponified gum rosin; alkyl esters of optionally partially hydrogenated rosin with low softening points, such as e.g. methyl, diethylene glycol, glycerol and pentaerythritol esters; terpene resins, in particular terpolymers or copolymers of terpene, such as styrene terpenes, α-methylstyrene terpenes, phenol-modified terpene resins and hydrogenated derivatives thereof; acrylic acid copolymers, preferably styrene-acrylic acid copolymers and resins based on functional hydrocarbon resins. The resins generally have a low molecular weight. They can be chemically inert or they can also carry functional groups, such as double bonds or OH groups. The resin can be used in a quantity of 0 to 50 wt. % and preferably from 10 to 40 wt. %, based on the hot-melt adhesive.

The adhesives according to the invention may optionally also contain proportions of adhesion promoters. These are, for example, silane compounds having hydrolyzable residues, for example alkoxy, acetoxy and halogen groups, and an organic substituent, which can also carry a further functional group. Examples of these are hydroxy-functional, (meth)acryloxy-functional, mercapto-functional, amino-functional or epoxy-functional silanes, such as 3-mercaptopropyltrimethoxysilane, 3-mercaptopropyltrimethoxysilane, 3-acryloxypropyltrialkoxysilane, 3-methacryloxypropyltrialkoxysilane, 3-aminopropyltrialkoxysilane, N-(2-aminoethyl)-3-aminopropyltrialkoxysilane, or their alkyldialkoxy analogs, in particular methoxy or ethoxy groups.

As plasticizers, for example medicinal white oils, naphthenic mineral oils, paraffinic hydrocarbon oils, phthalates, adipates, polypropylene, polybutene, polyisoprene oligomers, hydrogenated polyisoprene and/or polybutadiene oligomers, benzoate esters, vegetable or animal oils and derivatives thereof are used. As stabilizers or antioxidants that can be used, phenols, sterically hindered phenols of high molecular weight, polyfunctional phenols, sulfur- and phosphorus-containing phenols or amines can be selected. As pigments, for example titanium dioxide, talc, clay and the like can be selected. Optionally, waxes can be added to the hot-melt adhesive. The quantity should be calculated so that the adhesion is not adversely affected. The wax can be of natural or synthetic origin.

Furthermore, photosensitizers can additionally be used. Through the use of photosensitizers, it is possible to extend the absorption of photopolymerization initiators to shorter and/or longer wavelengths and in this way to accelerate curing. The specific wavelength of radiation absorbed by them is transferred to the photopolymerization initiator as energy. In the context of the invention, for example acetophenone, thioxanthanes, benzophenone and fluorescein and derivatives thereof can be used as photosensitizers.

Optionally, proportions of thermoplastic polymers can be present in the adhesives according to the invention, which can, for example, be polymers with a molecular weight greater than 1000 g/mol. They do not contain any reactive groups; in another embodiment, these polymers can have vinylically unsaturated groups. For example, polymers from the group of the polyacrylates, polymethacrylates and copolymers thereof, ethylene-n-butyl acrylate copolymers, ethylene-(meth)acrylic acid copolymers, ethylene-vinyl acetate copolymers, polyvinyl methyl ether, polyvinylpyrrolidone, polyethyl oxazolines, polyamides, starch or cellulose esters, amorphous polyolefins, for example polypropylene homopolymers, propylene-butene copolymers, propylene-hexene copolymers and in particular amorphous poly-alpha-olefin copolymers (APAO), which are produced by metallocene catalysis, are contained.

These additional polymeric components can be contained in the hot-melt adhesive according to the invention in an amount of 0 to 30 wt. %, and in particular 2 to 25 wt. %. The molecular weight is generally over 1000, preferably over 10 000 g/mol. The selection and properties of the thermoplastic polymers are known to the person skilled in the art. In total, the quantity of adhesive components should add up to 100%.

The above-mentioned hot-melt adhesives are solvent free and can be produced in a known manner. They are particularly suitable for the use according to the invention of bonding plastics substrates.

Preferred embodiments include a selection of additional constituents, such as
hot-melt adhesives, wherein the hot-melt adhesive is substantially free from isocyanate groups,
hot-melt adhesives, wherein N-methyl or N-ethyl diethanolamine or dimethylolpropionic acid or tartaric acid are reacted in,
hot-melt adhesives, wherein polymers based on polyesters, polyethers, polyamides or polyolefins with vinylic groups are additionally contained, which do not contain any urethane groups,
hot-melt adhesives, wherein auxiliary substances, such as resins, stabilizers, plasticizers and other photoinitiators, are additionally contained,
hot-melt adhesives, wherein the hot-melt adhesive is free from pigments or fillers,
hot-melt adhesives, wherein the viscosity at application temperature is from 2000 to 20 000 mPas, in particular measured at 130° C.,
hot-melt adhesives which additionally contain 0.1 to 10 wt. % of tri- to hexafunctional (meth)acrylic esters. This embodiment can be present individually or in combination.

The radiation-curable hot-melt adhesives according to the invention are particularly suitable for bonding sheet-like substrates with substrates of glass, metal, fabric, ceramic or plastics. Sheet-like substrates here can include labels, films, plastic strips, fabric surfaces or similar materials. The support materials of the film substrates are usually thin, flexible and optionally also elastic. They can be, for example, films of thermoplastic polymers, such as polyethylene, polypropylene, polystyrene, polyvinyl chloride or cellophane.

When the hot-melt adhesives that are suitable according to the invention are used, they are applied in the molten state onto the support material and cured in the subsequent process step by radiation. For problem-free processing, the hot-melt adhesives according to the invention should have an appropriately low viscosity before irradiation: at 130° C. it should usually be 500 mPas to 100 000 mPas and in particular up to 5000 mPas (measured with a Brookfield viscometer DV 2+, spindle 27, at the temperature indicated, in accordance with EN ISO 2555).

The hot-melt adhesives according to the invention have the required low viscosity at low processing temperatures, as is desired e.g. for use on temperature sensitive substrates. The processing temperatures are in the range of 50° C. to 150° C. and preferably in the range of 70° C. to 130° C. The processing is carried out using equipment which is known per se.

After application of the hot-melt adhesive according to the invention, the hot-melt adhesive according to the invention is irradiated with a sufficient UV or electron beam dose so that the adhesive layer is cured and has adequate mechanical stability and cohesion. The UV dose here, based on the UV-C fraction, should be greater than 10 mJ/cm², in particular greater than 20 mJ/cm² and preferably greater than 30 mJ/cm².

The tack can be influenced by the quantity of non-reactive chain ends. The cohesion of the cured adhesive is influenced by the quantity of unsaturated groups. This can be enhanced by the addition of polyfunctional reactive diluents.

A preferred form of use of the hot-melt adhesives according to the invention is the coating of self-adhesive films, tapes or labels comprising plastics films with an adhesive layer. In this case, tapes or films, for example based on polyolefins or polyesters, are coated with the hot-melt adhesive which is suitable according to the invention, and this is cured by radiation. In this case, by selecting an appropriate adhesive, a permanently pressure-sensitive adhesive layer is obtained. These materials can then be assembled. In this way, permanently tacky films, labels and strips can then be produced. The self-adhesive surfaces thus obtained can optionally be covered by anti-adhesively coated support films, which are removed for subsequent use.

Another embodiment uses the adhesives according to the invention for bonding films in the construction industry. It is necessary in this case to apply the adhesive layer in higher coating thicknesses. These can be from 50 to 500 μm. Even in this thickness, curing by radiation can be observed. Self-adhesive coatings with high adhesive strength are obtained. For example, self-adhesive films for roof coating can be produced in this way.

Preferred embodiments of the application methods include
use of these hot-melt adhesives for bonding films of PE, PP, PVC, polyester or polyamide,
use of the hot-melt adhesives according to the invention for bonding to substrates made of non-polar plastics, such as polyethylene, polypropylene, Teflon,
film substrates coated on one side, which have a pressure-sensitive adhesive layer comprising one of the adhesives according to the invention,
use for the overlapping bonding of film substrates, these being provided with an adhesive layer on the adherend surface on both sides facing the substrate.

The solvent-free hot-melt adhesives according to the invention produce a self-adhesive layer after curing. This is stable on storage and can subsequently be bonded. It has a high adhesive strength. The resulting network is built up evenly and there is improved adhesion and cohesion over a wide temperature range. It is also advantageous that, as a result of the initiators that are chemically reacted on, these do not migrate in the adhesive and cannot be separated. The adhesives can be used even in a thick layer and produce a cohesive, stable bond.

The subject matter of the invention will be explained in more detail by the following examples.

### EXAMPLE 1 (COMPARATIVE)

App.: 1-litre four-neck flask with stirrer, thermocouple, N2 pipe; height-adjustable oil bath, vacuum pump with a nitrogen-filled cold trap.

### Batch:

| | | |
|---|---|---|
| 1.) PPG 1000 | 200.00 g | polypropylene glycol |
| | | (OHV = 101) |
| 2.) PEG 600 | 50.5 g | polyethylene glycol |
| | | (OHV = 50) |
| 3.) Irganox B225 | 1.0 g | |
| 4.) IPDI | 77.6 g | (isophorone diisocyanate) |
| 5.) DBTL | 0.03 g | Sn catalyst |
| 6.) BHT | 0.3 g | |
| 7.) 2-Hydroxyethyl acrylate | 11.3 g | |
| 8.) Aliphatic alcohol | 15.5 g | (molecular weight 268 g/mol, |
| | | monohydric) |
| 9.) Irgacure 2959 | 8.7 g | |

### Test Procedure:

1, 2 and 3 were introduced and heated to about 120° C. Then, a vacuum was applied and water was removed at <10 mbar for 1 h and then the mixture was aerated with nitrogen. The temperature was reduced to 99° C., 4 was added and then the mixture was homogenized for 10 min. 5 was then added. The temperature increased. After 45 minutes, the NCO value was determined (approximately 2.47%). The mixture was then aerated with dry air.

6 was added, the mixture was homogenized, and then 7 was added with stirring at 100° C. 8 and 9 were added and after 1 hour the NCO value and viscosity were determined.

Melt viscosity 500 mPas at 120° C.; after 48 hours storage at 120° C., the viscosity was 460 mPas; NCO=0.025%.

Peel Test (ASTM D 1876): 2.3 N

### EXAMPLE 2

App.: as in Example 1

| | | |
|---|---|---|
| 1) PPG 1000 | 200.00 g | (OHV = 101) |
| 2) PPG 600 | 50.5 g | (OHV = 50) |
| 3) Irganox B225 | 1.0 g | (stabilizer) |
| 4) IPDI | 105.5 g | (isophorone diisocyanate) |
| 5) DBTL | 0.03 g | |
| 6) BHT | 0.4 g | |
| 7) 2-Hydroxyethyl acrylate | 10.1 g | |
| 8) Aliphatic alcohol | 8.0 g | (molecular weight 268 g/mol, |
| | | monohydric) |
| 9) Irgacure 2959 | 14.2 g | |
| 10) Dimethylolpropionic acid | 15.0 g | |

### Test Procedure:

1, 2, 3 and 10 were introduced and heated to approx. 120° C. Then, a vacuum was applied and water was removed at <10 mbar for 1 h and then the mixture was aerated with nitrogen. The temperature was reduced to 92° C., 4 was added and the mixture was homogenized for 10 min. 5 was then added, and the temperature increased. After 60 minutes the NCO value was determined (approximately 2.0%). The mixture was then aerated with dry air.

6 was added, the mixture was homogenized, and then 7 was added with stirring at 100° C. After 30 min, 8 and 9 were added and after 1 hour the NCO value and viscosity were determined.

Melt viscosity 1500 mPas at 120° C.; after 48 hours' storage at 120° C., the viscosity was 1850 mPas; NCO=0.03%.

### EXAMPLE 3

App.: as in Example 1

| | | | |
|---|---|---|---|
| 1.) PPG 1000 | 205 | g | (OHV = 101) |
| 2) PPG 600 | 51.0 | g | (OHV = 50) |
| 3) Irganox B225 | 1.0 | g | |
| 4) IPDI | 110.5 | g | (isophorone diisocyanate) |
| 5) DBTL | 0.02 | g | |
| 6) BHT | 0.4 | g | |
| 7) 2-Hydroxyethyl acrylate | 1.6 | g | |
| 8) Aliphatic alcohol | 2.2 | g | (molecular weight 268 g/mol, |
| | | | monohydric) |
| 9) Irgacure 2959 | 1.2 | g | |
| 10) N-Methyldiethanolamine | 15.5 | g | |

Test procedure:

1, 2, 3 and 10 were introduced and heated to approx. 120° C. Then, a vacuum was applied and water was removed at <10 mbar for 1 h and then the mixture was aerated with nitrogen. The temperature was reduced to 92° C., 4 was added and the mixture was homogenized for 10 min. 5 was then added, and the temperature increased. After 60 minutes the NCO value was determined (approximately 0.3%). The mixture was then aerated with dry air.

6 was added, the mixture was homogenized, and then 7 was added with stirring at 100° C. After 30 min, 8 and 9 were added and after 1 hour the NCO value and viscosity were determined.

Melt viscosity 1600 mPas at 120° C.; after 48 hours' storage at 120° C., the viscosity was 1850 mPas; NCO=0.0%.

A film of PET (50 μm) was coated with the adhesives and then irradiated (UV lamp, Loctite UVALOC 1000, Cure Chamber, UV-I dose 90 mJ/cm²).

The coating thickness of the adhesive was 50 μm.

The samples were bonded onto solid specimens of the substrates indicated with defined rolling. After 24 h the sample was measured.

| Test 1 | | | |
|---|---|---|---|
| (comparison) | Test 2 | Test 3 | Substrate |
| 0.8 | 2.0 | 0.9 | Loop tack [N] PET with PET |
| 1900 | >6950 | >2600 | Shear strength on steel [min] |
| 6.56 | 18.5 | 13.5 | Peel test on steel 180° [N] |
| 1.2 | 4.5 | 0.9 | Loop tack on glass |
| 0.9 | 3.8 | 1.1 | on PVC |
| 0.04 | 0.11 | 0.09 | on PTFE |
| 0.4 | 1.3 | 0.6 | on PS |
| >2520 | >4100 | >2580 | Shear test on PA6 [min] |

The loop tack is determined in accordance with FINAT Test Method 9.

The shear strength is determined in accordance with FINAT Test Method 8.

The peel value 180° is determined by FINAT Test Method 1.

It is shown that the bonds are better with the adhesives according to the invention than a comparative adhesive.

1. Radiation-curable hot-melt adhesives containing more than 30 wt. %, based on the hot-melt adhesive, of at least one polyurethane polymer which contains at least one radiation-polymerizable reactive group, produced by reaction of
a) a reactive PU prepolymer (A) with two or three NCO groups per molecule and at least one carboxyl group or tertiary amino group, produced from
i) a mixture of at least one di- or trifunctional polyol selected from polyether polyols or polyester polyols having a molecular weight of between 200 and 5000 g/mol together with a diol component which additionally has a carboxyl group or tertiary amino group, reacted with
ii) an excess of at least one di- or triisocyanate having a molecular weight of less than 500 g/mol,
b) 20 to 98 mole % of at least one low-molecular-weight compound (B) containing a free-radically polymerizable double bond and a group reacting with an NCO group, and
c) 0 to 50 mole % of at least one compound (C), which has at least one group that is reactive towards NCO groups but no group that can be polymerized under free-radical conditions, having a molecular weight of 32 to 5000 g/mol, and
d) 2 to 50 mole % of at least one free-radical photoinitiator (D) which has a primary or secondary OH group,
wherein the data are based on the NCO groups of the PU prepolymer and the sum of B, C and D should add up to 100 mole %,
and optionally other auxiliary substances.

2. The hot-melt adhesive according to claim 1, wherein aliphatic isocyanates are used as isocyanates (a ii).

3. The hot-melt adhesive according to claim 1, wherein the low-molecular-weight compound B) has a molecular weight below 1500 g/mol, in particular wherein OH-functional esters of (meth)acrylic acid are used.

4. The hot-melt adhesive according to claim 1, wherein the low-molecular-weight compound B) comprises OH-functional esters of (meth)acrylic acid having a molecular weight below 1500 g/mol.

5. The hot-melt adhesive according to claim 1, wherein 2 to 35 mole % mono- or difunctional alcohols are used as compound (C).

6. The hot-melt adhesive according to claim 1, wherein N-alkyldialkanolamines or dihydroxycarboxylic acids are contained as the diol component.

7. The hot-melt adhesive according to claim 1, wherein 4 to 40 mole % free-radical photoinitiators (D) which have a primary OH group are used.

8. The hot-melt adhesive according to claim 1, wherein the radiation-curable PU prepolymer contains 0.05 to 1 mmol/g COOH groups or tertiary amino groups.

9. The hot-melt adhesives according to claim 1, wherein 0.1 to 10 wt. % based on the hot-melt adhesive of trifunctional to hexafunctional (meth)acrylic acid esters are additionally contained.

10. The hot-melt adhesives according to claim 1, further comprising polymers based on polyesters, polyethers, polyamides or polyolefins with vinylic groups which do not contain any urethane groups.

11. The hot-melt adhesive according to claim 1, wherein the viscosity at 130° C. is from 2000 mPas to 20000 mPas.

12. An article comprising a pressure-sensitive adhesive layer on a plastic film, the pressure-sensitive adhesive layer prepared from the hot-melt adhesives according to claim 1.

13. The article according to claim 11, wherein the film is selected from PE, PP, PVC, polyester or polyamide.

14. The article according to claim 11 further comprising a mineral surface or plastic substrate bonded to the pressure-sensitive adhesive layer.

15. The article according to claim 11, wherein the hot-melt adhesive has a coating thickness of up to 500 μm.
